(19) United States
(12) Patent Application Publication
(10) Pub. No.: US 2012/0068442 A1
(43) Pub. Date: Mar. 22, 2012

(54) VEHICLE SEAT WITH AN AIRBAG DEVICE

(75) Inventor: Udo WAGNER, Ruesselsheim (DE)

(73) Assignee: GM GLOBAL TECHNOLOGY OPERATIONS LLC, Detroit, MI (US)

(21) Appl. No.: 13/233,868

(22) Filed: Sep. 15, 2011

(30) Foreign Application Priority Data
Sep. 18, 2010 (DE) 102010045969.0

(51) Int. Cl. B60R 21/207

(52) U.S. Cl. 280/730.2

(57) ABSTRACT

A vehicle seat is provided with an airbag device that has an airbag and a gas generator. A seat covering of the vehicle seat has a tear seam, which is connected to a tear section of a coupling element. In addition to the tear section, the coupling element has an assembly section that is connected to the airbag device or the vehicle seat. The tear section and assembly section of the coupling element are detachably connected to each other or a hinge is provided between the tear section and the assembly section.

### CROSS-REFERENCE TO RELATED APPLICATION

This application claims priority to German Patent Application No. 102010045969.0, filed Sep. 18, 2010, which is incorporated herein by reference in its entirety.

### TECHNICAL FIELD

The technical field relates to a vehicle seat with an airbag device.

### BACKGROUND

Several vehicle seats with airbag devices are known from the prior art. In order that the visual appearance of the vehicle seat is not adversely affected, such airbag devices are integrated into the vehicle seat, i.e., arranged in a cavity of the vehicle seat which in the case of a side airbag device is situated in a lateral region of the vehicle seat. In the event of an accident, gas is blown into an airbag of the airbag device by means of a gas generator. Due to the pressure of the filling airbag, a seat covering of the vehicle seat tears at a seam point and the airbag unfolds through the torn open seam point in a side region adjacent to the vehicle seat.

Depending on the seat covering material, which can for example be fabric, leather, artificial leather etc., the seat covering material can sometimes stretch greatly as a result of the expansion of the airbag before the seam point tears. Consequently it can occur that the seam point tears in an uncontrolled manner or not in the desired manner. As a result, the inflation behavior, inflation time and positioning time cannot be controlled precisely for a vehicle seat, but is in each case dependent on the seat covering material of the vehicle seat, which can vary in particular depending on production tolerances and age.

DE 10 2005 024 349 A1 discloses a vehicle seat with a side airbag device in which a coupling element is connected to the tear seam in the seat covering and the side airbag device. The coupling element consists of a textile material which stretches less than the seat covering of the vehicle seat when the same tension is applied to both components. Consequently, the coupling element ensures that the force exerted by the airbag during inflation of the airbag is transmitted directly to the tear seam and thus the seat covering material has little or no influence on the inflation and positioning process of the airbag device.

Therefore, at least one object is to improve a generic vehicle seat. In addition, other objects, desirable features and characteristics will become apparent from the subsequent summary and detailed description, and the appended claims, taken in conjunction with the accompanying drawings and this background.

### SUMMARY

According to an embodiment, a vehicle seat with an integrated airbag device is provided, in which a coupling element has a tear section and an assembly section, wherein the tear section is connected to a tear seam of a seat covering of the vehicle seat and the assembly section is connected to the airbag device, in particular to a housing or an airbag of the airbag device, and/or to the vehicle seat. A tear seam within the meaning of the present invention can be defined in particular as a seam, preferably a fiber and/or adhesive seam, between two seat covering parts, but also as a thin point, perforation or the like in one or a plurality of layers of a single-piece seat covering region.

According to a first embodiment, the tear section and the assembly section are connected detachably to each other. This advantageously allows convenient assembly, as first the tear section can be connected to the tear seam and the assembly section can be connected to the airbag device and/or the vehicle seat, before the tear section and the assembly section are connected to each other. Disassembly can advantageously also be improved in that first the tear section and the assembly section are detached from each other, so that for example the airbag device can be removed from the vehicle seat and for example replaced by another airbag device, while the tear section remains attached to the tear seam.

According to a second embodiment, a hinge is provided between the tear section and the assembly section. This can in particular effect a more defined opening characteristic, as a defined movement of the tear section and thus of the tear process is ensured by the hinge. Consequently, a defined opening in the seat covering can be ensured by the coupling element, via which opening the airbag can emerge in the side region adjacent to the vehicle seat.

A further advantage is that it can be ensured by the coupling element connected to the tear seam and to the airbag device, in particular the airbag thereof, and/or to the driver's seat, that the seat covering material has little or no influence on the tear process of the tear seam, as it is ensured by the coupling element that the force exerted on the coupling element by the airbag is completely or mostly transmitted into the tear seam and not into the seat covering. As a result, it can advantageously be ensured by the coupling element according to the invention that the seat covering material has little or no influence on the inflation and positioning process of the airbag device when the airbag device is activated.

In an embodiment, the coupling element exercises a guiding function for the expansion of the airbag of the airbag device. The coupling element can for example ensure that the airbag expands essentially in the direction of the tear seam or of the opening in the seat covering formed during the tear process when the airbag inflates.

In an embodiment, the tear section and the assembly section of the coupling element, which can each be formed preferably from plastic and/or metal, can be formed in one piece with the hinge, wherein the hinge can likewise be formed from plastic and/or metal. A plastic and/or metal having low mechanical elongation is preferably selected. Other materials can of course be used for the coupling element and the hinge, the materials preferably having lower mechanical elongation than the seat covering.

The hinge can at least partially be defined by a recess formed in the vehicle seat and/or an airbag device housing. The recess in the vehicle seat can be the recess in which the airbag device is arranged. Alternatively, the hinge can be provided by a recess in a cushion of the vehicle seat, which is formed in a form-fitting manner to form the hinge. A hinge is defined by the recess and/or the housing blocking or damping a movement of the assembly section in a form-fitting manner as a stop in at least one degree of freedom, in which the tear section can move essentially unhindered through the recess or housing. If for example the tear section and the assembly section butt against each other at an angle in an assembly position, wherein the sides of this angle which are formed by the assembly section bear on one side against a recess or a housing wall, this tear section pivots in a hinge-like manner about the vertex of this angle when force is exerted from inside onto the angle or onto the side formed by the tear section. Additionally or alternatively, a hinge can for example also be defined as a film hinge by a defined thin point in the coupling element or by an articulated connection of the tear section and the assembly section.

The tear section, which can be rotatable about the hinge, can be connected to the tear seam by means of a seam. By the same measure, it is possible for the tear section to be connected to the tear seam by adhesive bonding, riveting or another type of connection. The tear section is preferably connected to the tear seam in a non-detachable manner, in particular in a materially cohesive manner.

The assembly section of the coupling element can have a vertical section which is essentially parallel to a seat frame and to the tear section of the coupling element and can be arranged between the seat frame and the airbag device. Furthermore, the assembly section of the coupling element can have a horizontal section, which is connected at one end to the hinge and at the other end to an end of the vertical section. As a result of such a configuration of the tear section and of the assembly section of the coupling element, the non-activated airbag device can be enclosed by the coupling element on one or more sides. As a result, the non-activated airbag device is advantageously additionally stabilized inside the recess in the vehicle seat by the coupling element.

In a preferred embodiment, in which the tear section and the assembly section are connected detachably to each other, simple assembly of the airbag device is possible owing to the detachable connection. The coupling element can be of two-part or multi-part configuration, wherein the tear section and the assembly section of the coupling element each have for example a loop; in particular can be configured as loops. A loop of one section can then be connected to the other section, in particular to a loop of the other section, directly, for example by threading, knotting, looping or the like, or indirectly, in particular by means of an element which engages in both loops, for example a double hook, a cable ring or the like. Generally it can also be provided for the assembly section to be connected to the tear section by means of a detachable connection element.

A first loop of the coupling element can be connected to the tear seam of the seat covering and a second loop of the coupling element can be connected to the airbag of the airbag device. The first and second loops can be intertwined at their end which is remote from the tear seam and airbag in such a manner that a force can be transmitted via the second loop to the first loop and thus the tear seam in order to tear the seam open when the airbag inflates.

In a preferred embodiment, the airbag device can be arranged in the recess of the vehicle seat in such a manner that an expansion space is provided between the end of the airbag device which is remote from the tear seam and the cushion, into which expansion space the airbag of the activated airbag device can expand. Furthermore, the airbag device can have a first inflation space and a second inflation space, which are separated from each other by a dividing seam. The first inflation space can be formed in an end of the airbag device which is remote from the tear seam. When the airbag device is activated, the first inflation space in the vehicle seat can expand in a direction away from the tear seam, so that a tensile force is exerted on the tear seam via the coupling element, in particular via the tear section or the loop, which force results in the tear seam tearing open.

The dividing seam is preferably configured in such a manner that it only tears if the first inflation space has inflated and expanded in such a manner that the tear seam of the seat covering is torn open. After the dividing seam has torn open, the second inflation space can be inflated and the airbag expands in the direction of the opening formed during the tearing process and passes through the latter. Such inflation control of the airbag device ensures that the tear seam is already torn open before the second inflation space is inflated. As a result, such control can in a simple manner ensure an opening through which the airbag can emerge into the side region of the vehicle seat.

In an embodiment, in which the tear section and the assembly section of the coupling element are connected to a hinge, the hinge is arranged in the recess of the driver's seat in such a manner that a rotary movement of the tear section about a defined rotation axis is possible by the hinge being immobile relative to the vehicle seat when the first inflation space expands in the direction of the expansion space. When the first inflation space of the airbag of the airbag device expands into the expansion space, a force is exerted on the tear section of the coupling element so that the tear section of the coupling element rotates via the hinge in a direction in which a tensile force acts on the tear seam. As a result of the tensile force acting on the tear seam, the tear seam tears.

### BRIEF DESCRIPTION OF THE DRAWINGS

The present invention will hereinafter be described in conjunction with the following drawing figures, wherein like numerals denote like elements, and:

FIG. 1 shows a plan view of a vehicle seat with a non-activated airbag device and a coupling element according to a first embodiment;

FIG. 2 shows a plan view of the vehicle seat according to FIG. 1 with an activated airbag device;

FIG. 3 shows a plan view of a vehicle seat with a non-activated airbag device and a coupling element according to a second embodiment;

FIG. 4 shows a plan view of the vehicle seat according to FIG. 1, in which a first inflation space is inflated;

FIG. 5 shows a plan view of the vehicle seat according to FIG. 1, in which a second inflation space is inflated; and

FIG. 6 shows the vehicle seat according to FIG. 1, in which the airbag of the airbag device has emerged from an opening in a seat covering.

### DETAILED DESCRIPTION

The following detailed description is merely exemplary in nature and is not intended to limit application and uses. Furthermore, there is no intention to be bound by any theory presented in the preceding background or summary or the following detailed description.

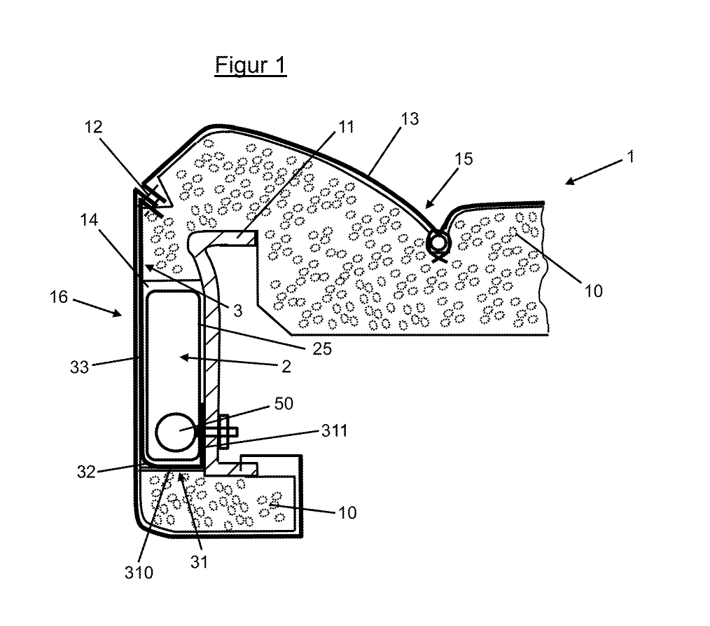

According to a first embodiment, the vehicle seat 1 shown in FIG. 1 has a seat frame 11, a cushion 10 and a seat covering 13. A front section 15 which faces a dashboard (not shown) of the vehicle and a side section 16 of the vehicle seat 1 which faces a vehicle door (not shown) are upholstered by means of the cushion 10. The seat covering 13 extends along the side of the cushion 10 facing the dashboard and the vehicle door and is provided with a plurality of seams, one of these seams being configured as a tear seam 12 which tears open when an airbag device 2 is activated. The same arrangement can of course also be configured in a reversed manner for a front passenger seat.

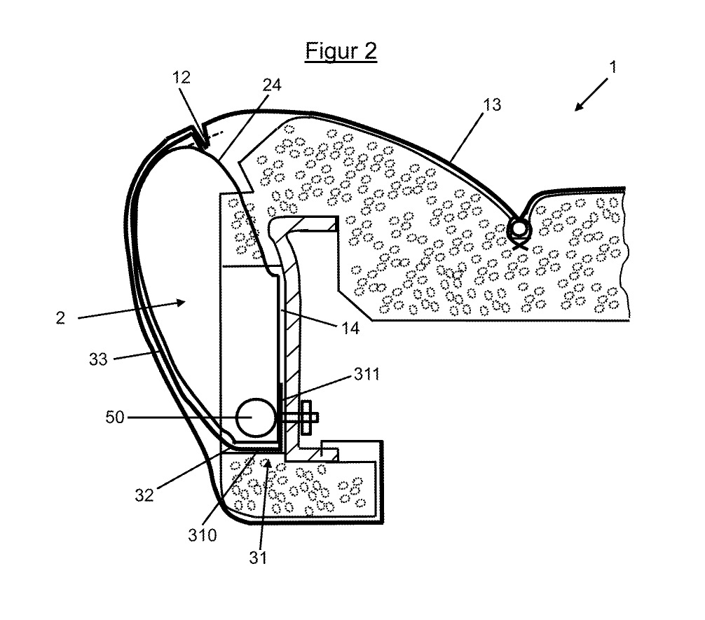

A recess 14 in which the airbag device 2 is accommodated is formed in the cushion 10 in the side section 16 of the vehicle seat 1. The recess 14 is defined by the seat frame 11, the cushion 10 and the seat covering 13. The airbag device 2 has an airbag device housing 25, an airbag 24 shown in FIG. 2 and a gas generator 50 for supplying gas to the airbag 24. The airbag 24 and the gas generator 50 are arranged inside the airbag device housing 25.

Furthermore, a coupling element 3 is provided in the vehicle seat 1. The single-piece coupling element 3 has a tear section 33, an assembly section 31 and a hinge 32. The tear section 33 of the coupling element 3 is connected at one end to the tear seam 12 and at the other end to the hinge 32 and can rotate about the hinge 32. The hinge 32 is defined by the recess 14, against which only the assembly section 31 is supported (vertically downward in FIG. 1) in a form-fitting manner, so that the tear section 33 can rotate freely about the edge of the recess 14 which is vertical on the upper left-hand side in the drawing plane of FIG. 1.

Additionally, a thinned portion of material (not shown) can be provided at this point between the tear section and the assembly section.

The assembly section 31 has a horizontal section 310 and a vertical section 311. The vertical section 311 is arranged between the seat frame 11 and the airbag device 2 and extends in the same direction as the tear section 33 of the coupling element 3. Furthermore, the vertical section 311 is connected to the seat frame 11. The horizontal section 310 is arranged between the airbag device 2 and the cushion 10 and connected at one end to the hinge 32 and at the other end to an end of the vertical section 311. Furthermore, the horizontal section 310 is arranged in the recess 14 in such a manner that it lies on the cushion 10. The horizontal section 310 extends in one direction which is essentially vertical to the direction of the vertical section 311. As a result of the coupling element 3 constructed in this manner, one side of the non-activated airbag device 2 is enclosed by the tear section and the assembly section of the coupling element 3 and is fixed in an immobile manner inside the recess 14. For fastening, the assembly section 31 is clamped between the housing 25 and the recess 14 by the airbag device housing and/or gas generator 50 being screwed to the seat frame.

FIG. 2 shows the vehicle seat 1 in a state in which the airbag device 2 is activated. The tear section 33 of the coupling element 3 is rotated about the hinge 32 in one direction by the expansion of the airbag 24, so that a tensile force acts on the tear seam 12. The assembly section 31 of the coupling element 3 is arranged in the recess 14 in such a manner that it does not move when the airbag 24 expands. FIG. 2 shows a state in which the airbag 24 has not yet expanded so far that the tensile force exerted on the tear seam 12 via the tear section 33 of the coupling element 3 causes tearing of the tear seam 12.

The tearing of the tear seam when the airbag device 2 is activated is explained below with reference to FIG. 1 and FIG. 2: When the airbag device 2 is activated, gas is conducted into the airbag 24 of the airbag device 2 via the gas generator 50, as a result of which the airbag 24 expands. As a result of the expansion of the airbag 24, a force is exerted by the latter onto the tear section 33 of the coupling element 3, which causes the tear section 33 of the coupling element 3 to rotate about the hinge 32, as shown in FIG. 2. A tensile force is exerted on the tear seam 12 by the rotation of the tear section 33 of the coupling element 3 about the hinge 32, which force causes the tear seam 12 to tear once said force exceeds a certain level. The expansion direction of the airbag 24 of the airbag device 2 is guided by the tear section 33 of the coupling element 3. It is thus ensured by the tear section 33 of the coupling element 3 that the airbag 24 expands in the direction of the tear seam 12.

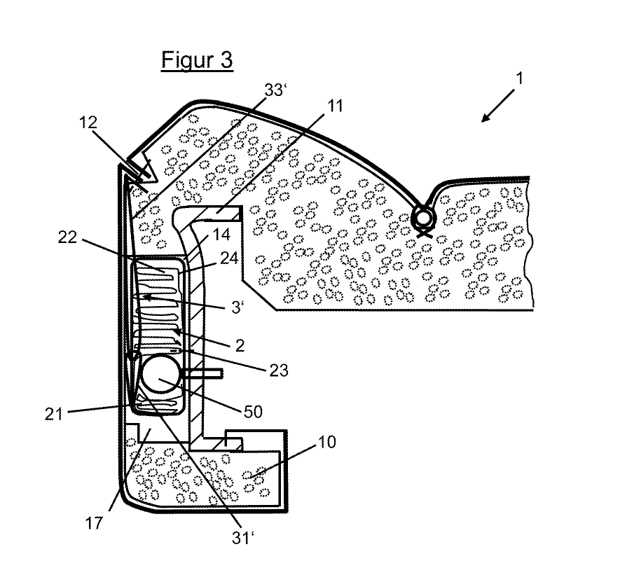

FIG. 3 to FIG. 6 shows a second embodiment. The second embodiment is similar to the first embodiment, so elements which correspond to each other are referred to with the same reference symbols and only the differences between the two embodiments are described below.

FIG. 3 shows a vehicle seat 1 with a non-activated airbag device 2 and a coupling element 3′ according to a second embodiment. The airbag 24 of the airbag device 2 has a first inflation space 21 and a second inflation space 22, which are separated from each other by means of a dividing seam 23. The first inflation space 21 of the airbag device 2 is provided in the end of the recess 14 which is remote from the tear seam 12, and the second inflation space is provided in the end of the recess 14 near the tear seam 12. The gas generator 50 is configured in such a manner that it supplies gas to the first inflation space 21 of the airbag 24 when the airbag device 2 is activated. The airbag device 2 is connected to the seat frame 11 by means of a connection (not shown in detail). The airbag device 2 is arranged in the recess 14 in such a manner that an expansion space 17 is provided between the end of the airbag device 2 which is remote from the tear seam 12 and the cushion 10.

The coupling element 3 has a tear section and an assembly section, which are connected detachably to each other and are configured as loops 33′, 31′. The first loop 33′ is connected at one end to the tear seam 12. The second loop 31′ is connected at one end to the airbag 24, preferably to the part of the airbag 24 which defines the first inflation space 21. The first loop 33′ and the second loop 31′ are intertwined with each other at their end which is remote from the tear seam 12 or airbag 24.

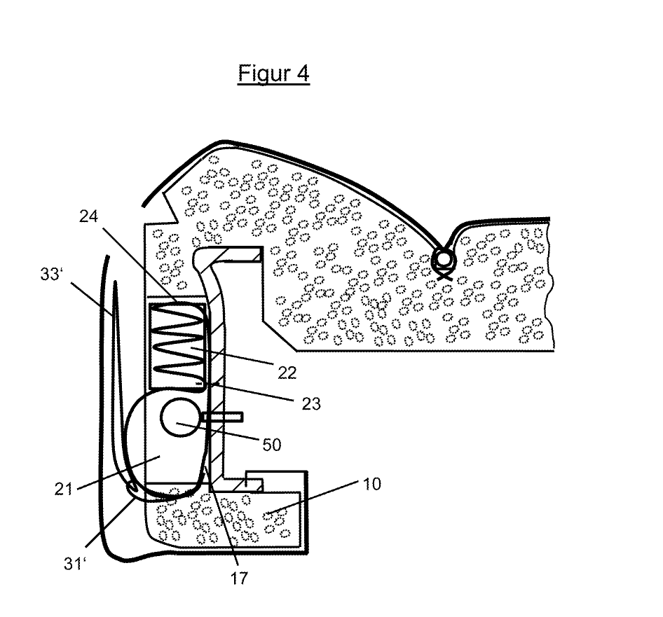

The tearing open of the tear seam 12 when the airbag device 2 is activated is explained below using FIG. 3 to FIG. 6. When the airbag device 2 is activated, first gas is conducted into the first inflation space 21 by the gas generator 50, as shown in FIG. 4. The first inflation space 21 expands in a direction away from the tear seam 12 into the expansion space 17 and presses against the cushion 10. When the first inflation space 21 expands, the second loop 31′ moves in correspondence with the expansion of the first inflation space 21 away from the tear seam 12 and into the cushion 10. Due to the coupling of the second loop 31′ to the first loop 33′, the first loop 33′ is moved analogously to the second loop 31′ in a direction away from the tear seam 12. As a result of this movement of the first loop 33′, a tensile force acts on the tear seam which is sufficient to tear open the tear seam 12.

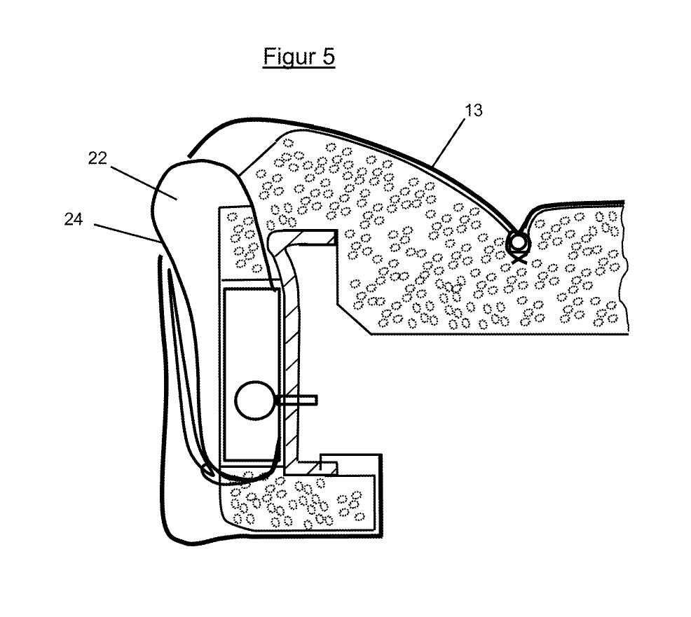

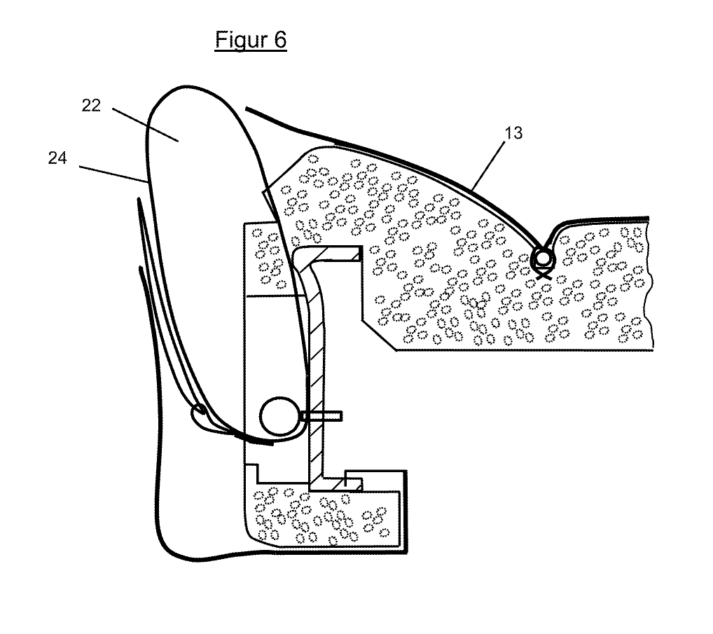

The dividing seam 23 tears as soon as the force exerted on the dividing seam 23 by the first inflation space 21 when the latter expands exceeds a certain limit value. As soon as this is case, the second inflation space 22 is filled with gas, as shown in FIG. 5. Due to the filling of the second inflation space 22 with gas, the airbag 24 expands in the direction of the opening in the seat covering 13 produced during the tearing process and emerges from the latter, as shown in FIG. 6. The gas generator 50 continues to supply gas to the first and second inflation spaces until the airbag 24 reaches its final position in the side region of the vehicle seat 1.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle seat with an integrated airbag device, comprising:
an airbag;
a gas generator;
a seat covering with a tear seam; and
a coupling element comprising a tear section of the coupling element connected to the tear seam and an assembly section of the coupling element connected to the integrated airbag device,
wherein the tear section is connected to the assembly section and connected detachably to each other or a hinge is formed between the tear section and the assembly section.

2. The vehicle seat according to claim 1, wherein the tear section is detachably connected to the assembly section.

3. The vehicle seat according to claim 1, wherein the hinge is formed between the tear section and the assembly section.

4. The vehicle seat according to claim 3, wherein the coupling element and the hinge are formed as one part.

5. The vehicle seat according to claim 3, wherein the vehicle seat has a recess that at least partially defines the hinge.

6. The vehicle seat according to claim 3, wherein the integrated airbag device has an airbag device housing that at least partially defines the hinge.

7. The vehicle seat according to claim 1, wherein an end of the assembly section facing away from the hinge is arranged between the integrated airbag device and a seat frame.

8. The vehicle seat according to claim 1, wherein the coupling element is produced at least partially from a metal.

9. The vehicle seat according to claim 1, wherein the coupling element is produced at least partially from a plastic.

10. The vehicle seat according to claim 1, wherein the tear section of the coupling element is configured to rotate about the hinge.

11. The vehicle seat according to claim 10, wherein the tear section of the coupling element is configured to rotate about the hinge about a defined rotation axis.

12. The vehicle seat according to claim 1, wherein the tear section of the coupling element has a loop.

13. The vehicle seat according to claim 1, wherein the assembly section of the coupling element has a loop.

14. The vehicle seat according to claim 1, further comprising a first inflation space and a second inflation space in the airbag and that are separated by a dividing seam.

15. The vehicle seat according to claim 14, wherein the dividing seam is configured to only tear after at least partial inflation of the first inflation space.

16. The vehicle seat according to claim 14, wherein a tensile force is exerted on the tear seam by the coupling element upon inflation of the first inflation space.
